(19) United States
(12) Patent Application Publication
(10) Pub. No.: US 2022/0112374 A1
(43) Pub. Date: Apr. 14, 2022

(54) POLYPHENYLENE SULFIDE RESIN COMPOSITION

(71) Applicant: Toray Resin Company, Shelbyville, IN (US)

(72) Inventors: So Wakao, Shelbyville, IN (US); Kazuki Akiba, Shelbyville, IN (US)

(73) Assignee: Toray Resin Company, Shelbyville, IN (US)

(21) Appl. No.: 17/070,208

(22) Filed: Oct. 14, 2020

(51) Int. Cl. C08L 81/02

(52) U.S. Cl. CPC C08L 81/02; C08L 2205/03

(57) ABSTRACT

The present invention relates to a polyphenylene sulfide resin composition. The polyphenylene sulfide resin composition contains (A) a polyphenylene sulfide resin, (B) a glycidyl group-containing copolymer containing an α-olefin and an α, β-unsaturated glycidyl ester, (C) a fluororesin (C), and (D) a carbon fiber. The present invention significantly improves the frictional wear characteristics of a molded product made from the polyphenylene sulfide resin composition, particularly at high temperature and in a solution. Further, the molded product made from the polyphenylene sulfide resin composition of the present invention has an excellent impact strength. Thus, the polyphenylene sulfide resin composition of the present invention is useful for electronic device parts, automobile parts, structural parts, mechanical parts, and oil drilling and transportation parts, for example.

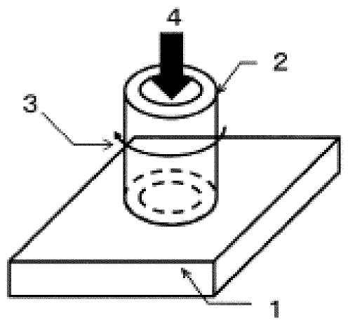

### FIELD OF THE INVENTION

The present invention relates to a polyphenylene sulfide (PPS) resin composition. The present invention significantly improves the friction and wear characteristics of a polyphenylene sulfide resin composition, and further the polyphenylene sulfide resin composition has excellent impact strength. Therefore, the polyphenylene sulfide resin composition is useful for electronic devices, automobile parts, structural parts, mechanical parts, oil drilling/transportation parts, etc. The present invention relates to such a resin composition and a molded product formed of the resin composition.

### TECHNICAL BACKGROUND

Sliding parts such as gears and switches are used in a variety of home appliances and automobile applications, etc. It is important to improve the sliding characteristics of slidable parts because it leads to improved fuel efficiency of home appliances and automobiles, for example. Further, in recent years, there has been increasing demand for miniaturization or downsizing of automobile engines and home appliance parts, and the more sophisticated specifications or properties have become more desired for sliding parts, and especially higher friction and wear resistance characteristics are required.

Further, in petroleum drilling and transportation applications, slidability of the molded product in petroleum is required during drilling and transportation, and high impact strength is also required in addition to frictional wear characteristics in such an environment (e.g., in solution or oil). For example, in WO 2017/131028, it is proposed that flexibility is imparted by blending a fluororesin with a polyphenylene sulfide resin, but there are problems including the frictional wear characteristics, particularly the frictional wear characteristics in a high temperature solution, are not sufficient. As another example, in WO 2012/117938, it is proposed that the slidability and frictional wear characteristics were improved by blending carbon fiber with the polyphenylene sulfide resin, but there were problems including the impact strength was not sufficient.

### SUMMARY OF INVENTION

The present invention significantly improves the frictional wear properties of a molded product made from a particular polyphenylene sulfide resin composition, especially at high temperatures and in solutions. Further, since the molded product made from the polyphenylene sulfide resin composition has excellent impact strength, it is useful for electronic devices, automobile parts, structural parts, mechanical parts, petroleum drilling/transportation parts, and the like.

For instance, the present application includes at least the following inventions.
1. A polyphenylene sulfide resin composition comprising:
   a polyphenylene sulfide resin (A);
   a glycidyl group-containing copolymer (B) containing an α-olefin and an α, β-unsaturated glycidyl ester;
   a fluororesin (C); and
   a carbon fiber (D),
wherein the polyphenylene sulfide resin composition has the following:
   5-20 parts by weight of the glycidyl group-containing copolymer (B),
   1-10 parts by weight of the fluororesin (C), and
   5-20 parts by weight of the carbon fiber (D) based on 100 parts by weight of the polyphenylene sulfide resin (A).
2. The polyphenylene sulfide resin composition according to above invention 1, wherein
   the polyphenylene sulfide resin composition is obtained by blending the polyphenylene sulfide resin (A), the glycidyl group-containing copolymer (B), particles of the fluororesin (C), and the carbon fiber (D), wherein
   the particles of the fluororesin (C) have average particle size of 1 μm to 30 μm determined in accordance with ISO 12086-2.
3. The polyphenylene sulfide resin composition according to above invention 1 or 2, wherein
   the glycidyl group-containing copolymer (B) is an ethylene/methyl acrylate/glycidyl methacrylate copolymer.
4. The polyphenylene sulfide resin composition according to any one of above inventions 1 to 3, wherein
   an amount of the glycidyl group-containing copolymer (B) is 8-16 parts by weight based on 100 parts by weight of the polyphenylene sulfide resin (A).
5. The polyphenylene sulfide resin composition according to any one of above inventions 1 to 4, wherein
   an amount of the fluororesin (C) is 2-8 parts by weight based on 100 parts by weight of the polyphenylene sulfide resin (A)

### BRIEF DESCRIPTION OF DRAWINGS

The FIGURE illustrates a method of a friction and wear test to measure the amount of wear in the Examples and Comparative Examples.

### REFERENCES IN THE FIGURE

1: Test plate (30 mm×30 mm×3 mm)
2. Cylindrical object made of SUS 304 (outer diameter: 25.6 mm×an inner diameter: 20 mm×height: 1 5 mm)
3: Direction of rotation of the cylindrical object 2
4: Direction of load applied to the test plate 1 (via the cylindrical object 2).

### DETAILED DESCRIPTION OF THE INVENTION

The polyphenylene sulfide resin composition comprises a polyphenylene sulfide resin (A), a glycidyl group-containing copolymer (B) containing an α-olefin and an α, β-unsaturated glycidyl ester, a fluororesin (C), and a carbon fiber (D), wherein 5-20 parts by weight of the glycidyl group-containing copolymer (B), 1-10 parts by weight of the fluororesin (C), and 5-20 parts by weight of the carbon fiber (D) are contained based on 100 parts by weight of the polyphenylene sulfide resin (A).

According to the present invention, the friction and wear characteristics of the molded product made from the polyphenylene sulfide resin composition, especially in high temperature and solution, are greatly improved. Further, the molded product made from the polyphenylene sulfide resin composition of the present invention has excellent impact strength, and thus, the resin composition is usable for improved molded articles such as electronic devices, automobile parts, structural parts, mechanical parts, oil excavation parts, and transportation parts.

(1) Polyphenylene Sulfide (PPS)

PPS resin (A) used in the present invention is a polymer having a repeating unit represented by the following structural formula (I):

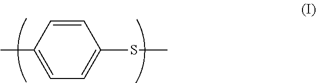

From the viewpoint of heat resistance, a polymer containing 70 mol % or more, more preferably 90 mol % or more of a polymer containing a repeating unit represented by the above structural formula (I) is preferred. Moreover, less than 30 mol % of the repeating units of the PPS resin may be composed of repeating units having the following structures:

Since in a PPS resin, the smaller the amount of chloroform that is extracted, the smaller the oligomer component, which lowers the chlorine content. Therefore, the amount of chloroform extracted from the (A) PPS resin used in the present invention is preferably 0.5% by weight or less for obtaining a low-salt resin composition, and further preferably 0.4% by weight or less.

When the amount of chloroform extracted from the PPS resin exceeds 0.5% by weight, the amount of chloroform extracted from the resin composition using the PPS resin is undesirably large. In the present invention, as a method for reducing the amount of chloroform extracted, in which a polymerization step and a post-treatment step are combined, is preferably used as described herein later. The chloroform extraction of (A) PPS resin in the present invention is performed with a Soxhlet extractor, by freeze-pulverizing the PPS resin, extracting the chloroform for 5 hours with 32 mesh pass, 2.0 gram of mesh particles of 42 mesh-on, and 200 ml of chloroform, then drying the extract at 50° C. The chloroform extraction amount is represented in percentage of the weight of the residue of the extract divided by the amount of the PPS resin sample used.

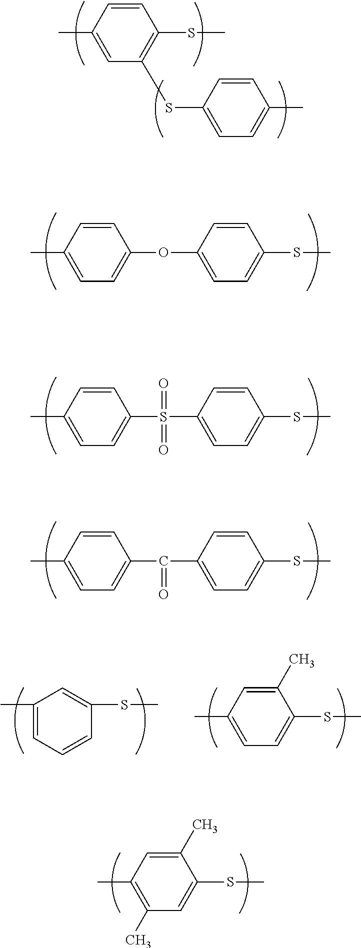

The melt viscosity of the (A) PPS resin used in the present invention is preferably in the range of 5 to 50 Pa·s (310° C., shear rate 1,216/s) from the viewpoint of obtaining a resin composition having excellent melt fluidity, and the range of 10 to 45 Pa·s is more preferable, and the range of 10 to 40 Pa·s is further more preferable. Two or more polyphenylene sulfide resins having different melt viscosities may be used in combination. The melt viscosity of the (A) PPS resin in the present invention is a value measured using a CAPILOGRAPH® manufactured by Toyo Seiki Co. under conditions of 310° C. and a shear rate of 1,216/s.

A manufacturing method of (A) PPS resin used for this invention is demonstrated below, if the PPS resin which has the structure and characteristic described above is obtained, it will not be limited to the following method. However, a method in which dichlorobenzene and a sulfur source are the main monomers (90 mol % or more) and polymerization is carried out in the presence of an aprotic polar solvent is most preferable in terms of production stability.

Next, the contents of the polyhalogenated aromatic compound, sulfidizing agent, polymerization solvent, molecular weight regulator, polymerization aid, and polymerization stabilizer used in the production will be described.

Polyhalogenated Aromatic Compounds

The polyhalogenated aromatic compound (PHA) used in the present invention refers to a compound having two or more halogen atoms in one molecule. Specific examples include polyhalogenated aromatics such as p-dichlorobenzene, m-dichlorobenzene, o-dichlorobenzene, 1,3,5-trichlorobenzene, 1,2,4-trichlorobenzene, 1,2,4,5-tetrachlorobenzene, hexachlorobenzene, 2,5-dichlorotoluene, 2,5-dichloro-p-xylene, 1,4-dibromobenzene, 1,4-diiodobenzene, and 1-methoxy-2,5-dichlorobenzene. Preferably, polychlorobenzene such as p-dichlorobenzene, m-dichlorobenzene, o-dichlorobenzene, 1,3,5-trichlorobenzene, 1,2,4-trichlorobenzene, and 1,2,4,5-tetrachlorobenzene is used. Among them, p-dichlorobenzene is particularly preferably used. It is also possible to combine two or more different polyhalogenated aromatic compounds into a copolymer, but a p-dihalogenated aromatic compound represented by p-dichlorobenzene is preferably used as a main component.

The polyhalogenated aromatic compound is used in an amount of 0.8 to 1.023 mol, preferably 0.8 to 1.020 mol, per 1 mol of the sulfidizing agent from the viewpoint of obtaining a PPS resin having a viscosity suitable for processing and low oligomer elution. Further, in the sense of achieving both a degree of polymerization useful for the present invention and low oligomer properties, a range of 0.9 to 1.015 mol is useful. In the case of the above range, a PPS resin in which the above-described chloroform extraction amount is in a preferable range can be obtained.

Sulfidizing Agent

A sulfidizing agent used in the present invention include alkali metal sulfides, alkali metal hydrosulfides, and hydrogen sulfide, for example.

Specific examples of the alkali metal sulfide include, for example, lithium sulfide, sodium sulfide, potassium sulfide, rubidium sulfide, cesium sulfide, and a mixture of two or more of these. Sodium sulfide is preferably used. These alkali metal sulfides can be used as hydrates or aqueous mixtures, or in the form of anhydrides.

Specific examples of the alkali metal hydrosulfide include, for example, sodium hydrosulfide, potassium hydrosulfide, lithium hydrosulfide, rubidium hydrosulfide, cesium hydrosulfide, and a mixture of two or more of these. Among these, sodium hydrosulfide is preferably used. These alkali metal hydrosulfides can be used as hydrates, aqueous mixtures, or in the form of anhydrides.

In addition, an alkali metal sulfide prepared in situ in a reaction system from an alkali metal hydrosulfide and an alkali metal hydroxide can also be used. Moreover, an alkali metal sulfide can be prepared from an alkali metal hydrosulfide and an alkali metal hydroxide, and transferred to a polymerization tank for use.

Alternatively, an alkali metal sulfide prepared in situ in a reaction system from hydrogen sulfide and an alkali metal hydroxide, such as lithium hydroxide or sodium hydroxide, can also be used. Moreover, an alkali metal sulfide can be prepared from hydrogen sulfide and an alkali metal hydroxide, such as lithium hydroxide or sodium hydroxide, and transferred to a polymerization tank for use.

In the present invention, the amount of the sulfidizing agent charged means the remaining amount obtained by subtracting the loss from the actual charged amount when a partial loss of the sulfidizing agent occurs before the start of the polymerization reaction due to the dehydration operation or the like.

An alkali metal hydroxide and/or an alkaline earth metal hydroxide can be used in combination with the sulfidizing agent. Specific examples of the alkali metal hydroxide include, for example, sodium hydroxide, potassium hydroxide, lithium hydroxide, rubidium hydroxide, cesium hydroxide, and a mixture of two or more thereof. Specific examples of the alkaline earth metal hydroxide include, for example, calcium hydroxide, strontium hydroxide, and barium hydroxide. Among these sodium hydroxide is preferably used.

When an alkali metal hydrosulfide is used as the sulfidizing agent, it is particularly preferable to use an alkali metal hydroxide at the same time, but the amount used is 0.90 to 1.10 mol, preferably 0.90 to 1.05 mol, and more preferably 0.95 to 1.02 mol, per 1 mol of alkali metal hydrosulfide, can be exemplified.

Polymerization Solvent

In the present invention, an organic polar solvent is used as a polymerization solvent. Specific examples include an aprotic organic solvent represented by N-alkylpyrrolidones such as N-methyl-2-pyrrolidone and N-ethyl-2-pyrrolidone, caprolactams such as N-methyl-ε-caprolactam, 1,3-dimethyl-2-imidazolide, N,N-dimethylacetamide, N,N-dimethylformamide, hexamethylphosphoric triamide, dimethyl sulfone, tetramethylene sulfoxide, and the like, and mixtures thereof.

These are preferably used because of their high reaction stability. Among these, N-methyl-2-pyrrolidone (hereinafter sometimes abbreviated as NMP) is particularly preferred.

The amount of the organic polar solvent used is selected in the range of 2.0 to 10 mol, preferably 2.25 to 6.0 mol, more preferably 2.5 to 5.5 mol, per 1 mol of the sulfidizing agent.

Molecular Weight Regulator

In the present invention, a monohalogenated compound (which may not necessarily be an aromatic compound) may be used in combination with the polyhalogenated aromatic compound described herein in order to form a terminal end of the PPS resin to be formed or to adjust a polymerization reaction or a molecular weight of the PPS resin.

Examples of the monohalogenated compound as the molecular weight regulator (or to adjust the polymerization reaction) include monohalogenated benzene, monohalogenated naphthalene, monohalogenated anthracene, monohalogenated compound containing 2 or more benzene rings, monohalogenated heterocyclic compound, and the like. Among them, monohalogenated benzene is preferable from the viewpoint of economy. Specifically, 2-chlorobenzoic acid, 3-chlorobenzoic acid, 4-chlorobenzoic acid, sodium 4-chlorophthalate, 2-amino-4-chlorobenzoic acid, 4-chloro-3-nitrobenzoic acid, and 4′-chlorobenzophenone-2-carboxylic acid can be used.

In view of reactivity during polymerization and versatility, 3-chlorobenzoic acid, 4-chlorobenzoic acid, and sodium 4-chlorophthalate are preferred. In addition, the monohalogenated compound can also be used for the purpose of adjusting the molecular weight of the PPS resin or for reducing the chlorine content of the PPS resin.

When the carboxyl group-containing monohalogenated compound is used, it contributes not only to an increase in the carboxyl group content, but also to a reduction in the chlorine content of the PPS resin.

Polymerization Aid

In the present invention, it is also a preferred embodiment to use a polymerization aid for adjusting the degree of polymerization. Here, the polymerization aid means a substance having an action of increasing the viscosity of the obtained PPS resin. Specific examples of such polymerization aids include, for example, alkali metal carboxylate, organic carboxylates, water, alkali metal chlorides, organic sulfonates, alkali metal sulfates, alkaline earth metal oxides, alkali metal phosphates, alkaline earth metal phosphates, and the like. These may be used alone or in combination of two or more. Among these, organic carboxylates, water, and alkali metal chlorides are preferable, and sodium and lithium carboxylates and/or water are particularly preferably used.

The alkali metal carboxylate described above is a compound represented by a general formula R(COOM)ₙ, wherein R is an alkyl group, cycloalkyl group, aryl group, alkylaryl group or arylalkyl group having 1 to 20 carbon atoms; M is an alkali metal selected from lithium, sodium, potassium, rubidium and cesium; and n is an integer of 1 to 3. Alkali metal carboxylates can also be used as hydrates, anhydrides, or aqueous solutions. Specific examples of the alkali metal carboxylate include, for example, lithium acetate, sodium acetate, potassium acetate, sodium propionate, lithium valerate, sodium benzoate, sodium phenylacetate, potassium p-toluate, and mixtures thereof.

The alkali metal carboxylate can be obtained by reaction of approximately equal chemical equivalents of an organic acid and one or more compounds selected from the group consisting of alkali metal hydroxides, alkali metal carbonates, and alkali metal bicarbonates. Among the alkali metal carboxylates described herein, lithium salts are highly soluble in the reaction system and have a large auxiliary effect, but are expensive, and potassium, rubidium and cesium salts are insufficiently soluble in the reaction system. Therefore, sodium acetate, which is inexpensive and has an appropriate solubility in the polymerization system, is preferably used.

When using these alkali metal carboxylates as polymerization aids, the amount used is usually from 0.01 to 2 mol per 1 mol of the charged sulfidizing agent from the viewpoint of obtaining a PPS resin having a viscosity suitable for processing and oligomer low elution. In the range of 0.010 to 0.088 mol is preferable from the viewpoint of achieving both the degree of polymerization useful for the present invention and low oligomer property. In the case the above range is used, a PPS resin having the above-described melt viscosity in a preferable range can be obtained.

In addition, when water is used as a polymerization aid, the addition amount is usually in the range of 0.3 mol to 15 mol per 1 mol of the charged sulfidizing agent, and in the sense of obtaining a higher degree of polymerization, 0.6 to 10 mol is preferable, and the range of 1 to 5 mol is more preferable. Of course, two or more kinds of these polymerization aids can be used in combination. For example, when an alkali metal carboxylate and water are used in combination, a higher molecular weight can be obtained in a smaller amount than when each is used alone.

There is no particular designation as to the timing of addition of these polymerization aids, which may be added at any time during a pre-process, at a polymerization start, or during a polymerization which will be described later, or may be added in multiple times. When using an alkali metal carboxylate as a polymerization aid, it is more preferable to add it at a start of the pre-process or at a start of the polymerization from the viewpoint of easy addition. When water is used as a polymerization aid, it is effective to add the water during the polymerization after the polyhalogenated aromatic compound is charged.

Polymerization Stabilizer

In the present invention, a polymerization stabilizer may be used to stabilize the polymerization reaction system and prevent side reactions. The polymerization stabilizer contributes to stabilization of the polymerization reaction system and suppresses undesirable side reactions. One measure of the side reaction is the generation of thiophenol, and the addition of a polymerization stabilizer can suppress the generation of thiophenol. Specific examples of the polymerization stabilizer include compounds such as alkali metal hydroxides, alkali metal carbonates, alkaline earth metal hydroxides, and alkaline earth metal carbonates. Among these, alkali metal hydroxides, such as sodium hydroxide, potassium hydroxide, and lithium hydroxide, are preferred.

Since the alkali metal carboxylate described herein also acts as a polymerization stabilizer, it may be one of the polymerization stabilizers used in the present invention. In addition, when an alkali metal hydrosulfide is used as a sulfidizing agent as described herein, that it is particularly preferable to use an alkali metal hydroxide at the same time. Alkali metal hydroxides in excess relative to the sulfidizing agent can also serve as a polymerization stabilizer.

These polymerization stabilizers can be used alone or in combination of two or more. The polymerization stabilizer is preferably used with an amount of usually 0.02 to 0.2 mol, preferably 0.03 to 0.1 mol, and more preferably 0.04 to 0.09 mol, in proportion relative to 1 mol of the charged sulfidizing agent. If this proportion is too small, the stabilizing effect is insufficient conversely, if the proportion is too large, it is economically disadvantageous or the polymer yield tends to decrease.

There is no particular designation as to the timing of addition of these polymerization stabilizers, which may be added at any time during a pre-process, at a polymerization start, or during a polymerization, or may be added in multiple times. It is more preferable to add at the start of the pre-process or at the start of polymerization from the viewpoint of easy addition.

Next, the production method of the (A) PPS resin used in the present invention will be specifically described in the order of the pre-process, polymerization reaction process, recovery process, and post-treatment process.

Pre-Process

In the method for producing the (A) PPS resin used in the present invention, the sulfidizing agent is usually used in the form of a hydrate. It is preferable to raise the temperature of the mixture including an organic polar solvent and the sulfidizing agent and to remove an excessive amount of water out of the system before adding the polyhalogenated aromatic compound.

As described above, a sulfidizing agent prepared from an alkali metal hydrosulfide and an alkali metal hydroxide in situ in the reaction system, or in a tank different from the polymerization tank is also used as the sulfidizing agent.

Although there is no particular limitation on this method, desirably an alkali metal hydrosulfide and an alkali metal hydroxide are added to the organic polar solvent in an inert gas atmosphere at a temperature ranging from room temperature to 150° C., preferably from room temperature to 100° C., then, the water is distilled away by raising the temperature to at least 150° C. or more, preferably 180 to 260° C. under normal or reduced pressure. Polymerization aids can be added at this stage. In addition, toluene, etc., can be added for the reaction to accelerate the distillation of the water.

The amount of water in the polymerization system in the polymerization reaction is preferably 0.3 to 10.0 moles per 1 mole of the sulfidizing agent charged. Here, the amount of water in the polymerization system is an amount obtained by subtracting the amount of water removed out of the polymerization system from the amount of water charged in the polymerization system. In addition, the water to be charged may be in any form such as water, an aqueous solution, and crystal water.

Polymerization Reaction Step

In the present invention, a PPS resin is produced by reacting a sulfidizing agent and a polyhalogenated aromatic compound in an organic polar solvent within a temperature range of 200° C. or higher and lower than 290° C. When starting the polymerization reaction step, the organic polar solvent, the sulfidizing agent and the polyhalogenated aromatic compound are mixed desirably in an inert gas atmosphere at a temperature between room temperature to 240° C., preferably in the range between 100 to 230° C. A polymerization aid may be added at this stage. The order in which these raw materials are charged may be random or may be simultaneous.

Such a mixture is usually heated to a temperature in the range of 200° C. to 290° C. Although there are no particular limitations on the rate of temperature increase, a rate of 0.01 to 5° C./min is usually selected, and a range of 0.1 to 3° C./min is more preferable. In general, the temperature is finally raised to a temperature between 250 and 290° C., and the reaction is usually carried out at that temperature for 0.25 to 50 hours, preferably 0.5 to 20 hours. In the stage before reaching the final temperature, for example, a method of reacting at a temperature between 200° C. and 260° C. for a certain amount of time and then raising the temperature to between 270° C. and 290° C., is effective in obtaining a higher degree of polymerization. In this case, the reaction time at the temperature between 200° C. and 260° C. is usually selected in the range of 0.25 to 20 hours, preferably in the range of 0.25 to 10 hours. Other times, such as 0.5, 1, 5, etc. hours are contemplated.

In order to obtain a polymer having a higher degree of polymerization, it may be effective to perform polymerization in multiple stages. When the polymerization is performed in a plurality of stages, it is effective to advance to the next stage when the conversion of the polyhalogenated aromatic compound in the system at 245° C. reaches 40 mol % or more, preferably 50 mol % or more, and more preferably 60 mol %.

Further, the conversion rate of the polyhalogenated aromatic compound is a value calculated by the following formula. The residual amount of PHA can usually be determined by gas chromatography.
(a) When polyhalogenated aromatic compound is excessively added at a molar ratio to the alkali metal sulfide:

Conversion rate=[PHA charged (mol)−PHA residual amount (mol)]/[PHA charged (mol)−PHA excess amount (mol)].
(b) In cases other than (a) above:

Conversion rate=[PHA charged (mole)−PHA residual amount (mole)]/[PHA charged (mole)].

Recovery Process

In the method for producing the (A) PPS resin used in the present invention, a solid material is recovered from a polymerization reaction product containing a polymer, a solvent and the like after the completion of polymerization. Any known recovery method may be adopted for the PPS resin used in the present invention.

For example, after completion of the polymerization reaction, a method of slowly cooling and recovering the particulate polymer may be used. The slow cooling rate at this time is not particularly limited, but is usually about 0.1° C./min to 3° C./min. There is no need for slow cooling to be at the same rate in the whole process of the slow cooling step, and a method of slow cooling at a rate of 0.1 to 1° C./min until the polymer particles crystallize and then at a rate of 1° C./min or more, may be adopted. When the above recovery method is used, a PPS resin in which the above-described chloroform extraction amount is in a preferable range can be obtained.

Moreover, it is also one of the preferable methods to perform said recovery under quenching conditions. A Flash method is one of the preferable methods of this recovery method. The Flash method is a method in which a polymerization reaction product is flashed from a high-temperature and high-pressure state (normally 250° C. or higher, 8 kg/cm′ or higher) into an atmosphere of normal pressure or reduced pressure, and the polymer is recovered in powder form simultaneously with solvent recovery. In this case, the flash means that the polymerization reaction product is ejected from a nozzle. Specific examples of the atmosphere to be flashed include nitrogen or water vapor at normal pressure, and the temperature is usually selected from the range of 150° C. to 250° C.

Among them, in order to develop a more excellent low oligomer property, a method of slowly cooling after the completion of the polymerization reaction and recovering the particulate polymer is preferably used in order to increase the cleaning effect with the organic solvent described later.

Post-Processing Process

The (A) PPS resin used in the present invention may be produced through the above polymerization and recovery steps and then subjected to acid treatment, hot water treatment or washing with an organic solvent.

When acid treatment is performed, it is as follows. The acid used for the acid treatment of the PPS resin in the present invention is not particularly limited as long as it does not have an action of decomposing the PPS resin, and examples thereof include acetic acid, hydrochloric acid, sulfuric acid, phosphoric acid, silicic acid, carbonic acid, and propyl acid. Of these, acetic acid and hydrochloric acid are more preferably used, but those that decompose and deteriorate the PPS resin such as nitric acid are not preferable.

As the acid treatment method, there is a method of immersing the PPS resin in an acid or an acidic aqueous solution, and it is possible to appropriately stir or heat as necessary. For example, when acetic acid is used, a sufficient effect can be obtained by immersing the PPS resin powder in an aqueous pH 4 solution heated to between 80 and 200° C. and stirring for 30 minutes. The pH after the treatment may be 4 or more, for example, about pH 4-8. The acid-treated PPS resin is preferably washed several times with water or warm water in order to remove residual acid or salt. The water used for washing is preferably distilled water or deionized water in the sense that the effect of the preferred chemical modification of the PPS resin by acid treatment is not impaired.

When performing hot water treatment, it is as follows. In the hot water treatment of the PPS resin used in the present invention, the temperature of the hot water is preferably 100° C. or higher, more preferably 120° C. or higher, further preferably 150° C. or higher, and particularly preferably 170° C. or higher. Less than 100° C. is not preferable because the effect of preferable chemical modification of the PPS resin is small.

The water used is preferably distilled water or deionized water in order to express the preferable chemical modification effect of the PPS resin by the hot water washing according to the present invention. There is no particular limitation on the operation of the hot water treatment, and a predetermined amount of PPS resin is put into a predetermined amount of water and heated and stirred in a pressure vessel, or a continuous hot water treatment is performed. The ratio of water is preferably higher than that of the PPS resin, but usually a bath ratio of 200 g or less of PPS resin is selected for 1 liter of water.

Further, since the decomposition of the terminal group is not preferable, the treatment atmosphere is preferably an inert atmosphere in order to avoid decomposition of the terminal group. Further, the PPS resin after the hot water treatment operation is preferably washed several times with warm water in order to remove remaining components.

The organic solvent used for washing the PPS resin in the present invention is not particularly limited as long as it does not have a function of decomposing the PPS resin. For example, polar solvents containing nitrogen such as N-methyl-2-pyrrolidone, dimethylformamide, dimethylacetamide,1,3-dimethylimidazolidinone, hexamethylphosphoramide, and piperazinones; sulfoxide-sulfone series solvents such as dimethyl sulfoxide, dimethyl sulfone, and sulfolane; ketone series solvents such as acetone, methyl ethyl ketone, diethyl ketone, and acetophenone; ether series solvents such as dimethyl ether, dipropyl ether, dioxane, and tetrahydrofuran; halogen series solvents such as chloroform, methylene chloride, trichloroethylene, ethylene dichloride, perchlorethylene, monochloroethane, dichloroethane, tetrachloroethane, perchlorethane, and chlorobenzene; and aromatic hydrocarbon series solvents such as benzene, toluene and xylene, can be used.

Among these organic solvents, the use of NMP, acetone, dimethylformamide, chloroform and the like is preferable, and the use of N-methyl-2-pyrrolidone is particularly preferable in terms of obtaining an excellent oligomer removal effect. These organic solvents are used alone or in combination of two or more.

As a method of washing with an organic solvent, there is a method of immersing a PPS resin in an organic solvent, and if necessary, stirring or heating can be appropriately performed. There is no particular limitation on the washing temperature when washing the PPS resin with organic solvents, and any temperature from room temperature to about 300° C. can be selected. The higher the washing temperature, the higher the washing efficiency tends to be. However, a sufficient effect is usually obtained at a washing temperature of room temperature to 150° C. It is also possible to wash under pressure in a pressure vessel at a temperature above the boiling point of the organic solvent.

There is no particular limitation on the washing time. Depending on the washing conditions, in the case of batch-type washing, a sufficient effect can be obtained usually by washing for 5 minutes or more. It is also possible to wash in a continuous manner. Such washing with organic solvents is a process suitable for the production of the (A) PPS resin used in the present invention because a high oligomer removal effect is obtained.

In the present invention, the polyphenylene sulfide resin obtained as described above may be treated by washing with water containing an alkaline earth metal salt. The following method can be illustrated as a specific method when the polyphenylene sulfide resin is washed with water containing an alkaline earth metal salt. There are no particular limitations on the type of alkaline earth metal salt, but alkaline earth metal salts of water-soluble organic carboxylic acids such as calcium acetate and magnesium acetate are preferable examples, and alkaline earth metal salts of water-soluble organic carboxylic acids such as calcium acetate and magnesium acetate are particularly preferable.

The temperature of water is preferably room temperature to 200° C., more preferably 50 to 90° C. The amount of the alkaline earth metal salt used in the water is preferably 0.1 to 50 g, more preferably 0.5 to 30 g, for 1 kg of the dried polyphenylene sulfide resin. The washing time is preferably 0.5 hours or longer, and more preferably 1.0 hour or longer. The preferred washing bath ratio (weight of warm water containing alkaline earth metal salt per unit weight of dry polyphenylene sulfide resin) depends on the washing time and temperature, but it is preferable to wash using preferably 5 kg or more, or more preferably 10 kg or more of warm water containing alkaline earth metal per 1 kg of dry polyphenylene sulfide.

There is no limitation in particular as an upper limit and it can be high as to the amount of warm water containing alkaline earth metal, it is preferable that it is 100 kg or less from the point of the usage-amount and the effect acquired. Such warm water washing may be performed a plurality of times.

The (A) PPS resin used in the present invention can also be used after having been polymerized by heating in an oxygen atmosphere and a thermal oxidation crosslinking treatment by heating with addition of a crosslinking agent such as peroxide.

In the case of dry heat treatment for the purpose of increasing the molecular weight by thermal oxidation crosslinking, the temperature is preferably in the range of 160 to 260° C., more preferably 170 to 250° C. The oxygen concentration during treatment is preferably 5% by volume or more, more preferably 8% by volume or more.

Although there is no limitation in particular in the upper limit of oxygen concentration, about 50 volume % may be a limit. The treatment time is preferably 0.5 to 100 hours, more preferably 1 to 50 hours, and further preferably 2 to 25 hours. The heat treatment apparatus may be a normal hot air drier or a heating apparatus with a rotary or stirring blade. But in order to process efficiently and more uniformly, it is more preferable to use a heating apparatus with a rotary type or a stirring blade.

However, from the viewpoint of achieving both low oligomer elution and excellent melt fluidity, the introduction of a cross-linked structure is less preferred, and a linear PPS is preferred.

Further, dry heat treatment can be performed for the purpose of suppressing thermal oxidative cross-linking and removing volatile matter. The temperature is preferably in the range of 130 to 250° C., more preferably 160 to 250° C. In this case, the oxygen concentration is preferably less than 5% by volume, and more preferably less than 2% by volume.

The treatment time is preferably 0.5 to 50 hours, more preferably 1 to 20 hours, and even more preferably 1 to 10 hours. The heat treatment apparatus may be a normal hot air drier or a heating apparatus with a rotary or stirring blade but in order to process efficiently and more uniformly, it is more preferable to use a heating apparatus with a rotary type or a stirring blade.

In the present invention, the use of a PPS resin in which the ash content of the PPS resin is reduced to 0.2% by weight or less by deionization treatment or the like is preferable in terms that the resin composition containing the PPS resin has better toughness and molding processability. Specific examples of such deionization treatment include acid aqueous solution washing treatment, hot water washing treatment, and organic solvent washing treatment, and these treatments may be used in combination of two or more methods.

In addition, the following methods are mentioned here for the measurement of the amount of ash. About 5 g of dry PPS bulk powder is weighed into a platinum crucible and baked until it becomes a black lump on an electric stove. Next, the firing is continued in the electric furnace set at 550° C. until the carbide is completely fired. Thereafter, after cooling in a desiccator, the weight is measured, and the ash content can be calculated from the comparison with the initial weight. The lower limit of the ash content of the PPS resin is ideally 0, but a PPS resin having an ash content of 0.1% by weight or more can be preferably used.

For example, by adopting the production method as described above, it is possible to obtain (A) PPS resin having excellent low oligomer dissolution property and melt fluidity, which can thus be used for the various applications mentioned herein.

(2) Glycidyl Group-Containing Copolymer Comprising α-Olefin and α, β-Unsaturated Glycidyl Ester as copolymerization components

The glycidyl group-containing copolymer comprising (B) an α-olefin and an α, β-unsaturated glycidyl ester as a copolymerization component according to the present invention includes a copolymer obtained from an α-olefin, and an α, β-unsaturated glycidyl ester, and when necessary, a copolymer by copolymerizing an unsaturated acid monomer which is copolymerizable with them. It is preferable to use 60% by weight or more of α-olefin and α, β-unsaturated glycidyl ester in the total copolymer components.

Examples of the α-olefin include ethylene, propylene, 1-butene, 1-pentene, 1-octene, and the like. Two or more of these may be used. Examples of the glycidyl ester of α, β-unsaturated acid include glycidyl acrylate, glycidyl methacrylate, glycidyl ethacrylate, and glycidyl itaconate. Two or more of these may be used. Glycidyl methacrylate is preferably used. Examples of unsaturated acid monomers copolymerizable with the above components include vinyl esters such as vinyl ethers, vinyl acetate, and vinyl propionate; acrylic acid and methacrylate esters such as methyl, ethyl, propyl, and butyl; acrylonitrile; and styrene. Two or more of these may be used.

Preferred examples of the glycidyl group-containing copolymer comprising (B) an α-olefin and a glycidyl ester of α, β-unsaturated acid in the present invention as a copolymerization component include ethylene/glycidyl methacrylate copolymer, ethylene/glycidyl methacrylate/vinyl acetate copolymer, ethylene/glycidyl methacrylate/acrylic ester copolymer, ethylene/glycidyl acrylate/vinyl acetate copolymer, and the like. Two or more of these may be used.

Ethylene/methylacrylate/glycidyl methacrylate copolymer is most preferable from the viewpoint of impact characteristics (e.g., impact strength). It is available from Arkema under the trade name Rotada AX8900. In the present embodiment, the amount of (B) the glycidyl group-containing copolymer containing α-olefin and glycidyl ester of α, β-unsaturated acid is 5 to 20 parts by weight, and preferably 8 to 16 parts by weight, based on 100 parts by weight of the PPS resin A). When the amount of (B) the glycidyl group-containing copolymer containing α-olefin and glycidyl ester of α, β-unsaturated acid is 5 parts by weight or more, an impact strength of the articles is further enhanced. When the amount of (B) the glycidyl group-containing copolymer containing α-olefin and glycidyl ester of α, β-unsaturated acid is 10 parts by weight or less, friction wear characteristics are further enhanced.

(3) Fluororesin

The amount of the fluororesin (C) in the present embodiment is 1 to 10 parts by weight, preferably 2 to 8 parts by weight, based on 100 parts by weight of the PPS resin (A). When the amount of fluororesin is 1 part by weight or more, preferable friction and wear characteristics of the molded product are attained. On the other hand, when its amount is 10 parts by weight or less, preferable impact characteristics of the molded product are attained.

In the present invention, it is preferable for the fluororesin (C) to have a polymerization unit based on at least one fluorine-containing monomer selected from the group consisting of: tetrafluoroethylene (TFE); vinylidene fluoride (VdF); chlorotrifluoroethylene (CTFE); vinyl fluoride (VF); hexafluoropropylene (HFP); hexafluoro isobutene (HFIB); a monomer represented by CH₂═CX1(CF₂)nX2, where X1 is H or F, X2 is H, F or Cl, and n is an integer of 1 to 10; perfluoro (alkyl vinyl ether) (PAVE) represented by CF₂═CF—ORfl, where Rf1 represents a perfluoroalkyl group having 1 to 8 carbon atoms; alkyl perfluorovinyl ether derivative represented by CF₂═CF—OCH₂—Rf2, where Rf2 is a perfluoroalkyl group having 1 to 5 carbon atoms; trifluoroethylene; trifluoropropylene; tetrafluoropropylene, pentafluoropropylene; trifluorobutene; tetrafluoroisobutene; and iodine-containing fluorinated vinyl ether. The fluororesin (C) may be a homopolymer of the above-mentioned fluorine-containing monomer, or a modified fluororesin (e.g., copolymer, where a co-monomer is copolymerized to the above-mentioned fluorine-containing monomer to the extent that the effects of the present invention are not impaired) alone or in combination. In this embodiment, it is preferable to employ a homopolymer of a fluorine-containing monomer.

The melting point of the fluororesin (C) is preferably 140 to 340° C., more preferably 160 to 320° C., from the viewpoint of the appearance of the obtained molded product. The melting point of 180 to 300° C. is further preferred. The melting point is a temperature corresponding to the maximum value in the enthalpy of fusion curve when the temperature is raised at a rate of 10° C./minute using a differential scanning calorimeter (DSC).

It is preferable that (C) fluororesin has a melt flow rate (MFR) of 0.1 to 300 g/10 minutes at 372° C. If the MFR is too small, the friction property may be lowered and non-adhesiveness may be inferior. If the MFR is too large, the wear resistance may be inferior. The MFR is a value obtained by measuring at a temperature of 372° C. and a load of 5 kg in accordance with ASTM D1238.

The average particle size of the fluororesin is preferably 1 μm to 50 more preferably 1 μm to 30 μm in accordance with ISO 12086-2. When the average particle size is 1 μm or larger, the friction and wear characteristics of the molded product are superior. When the average particle size is 50 μm or less, the impact strength of the molded product is superior.

(4) Carbon Fiber

Amount of the carbon fiber content (D) is 5 to 20 parts by weight, preferably 8 to 18 parts by weight, and more preferably 10 to 15 parts by weight with respect to 100 parts by weight of the PPS resin (A). When the carbon fiber content is in the range of 5 to 20 parts by weight with respect to 100 parts by weight of the PPS resin (A), the excellent balance between the frictional wear characteristics and the impact characteristics, which are desired for the molded product containing the carbon fiber content, is attained. When the carbon fiber (D) is less than 5 parts by weight, the impact strength of the molded product tends to be lowered. On the other hand, When the carbon fiber (D) is 18 parts by weight or more, although the impact strength of the molded product becomes high, the frictional wear characteristic become inferior.

Examples of the carbon fiber (D) include a PAN-based carbon fiber, which is made from polyacrylonitrile (PAN) fiber; a pitch-based carbon fiber, which made from petroleum tar or petroleum pitch; a cellulose-based carbon fiber, which is made from viscose rayon or cellulose acetate; a vapor-phase growth carbon fiber, which is made from hydrocarbons; and a graphitized fiber thereof. Among these carbon fibers, PAN-based carbon fibers are preferably usable because they have an excellent balance between a strength and an elastic modulus.

In the polyphenylene sulfide resin composition in the present invention, other components can be added within the range not impairing the effects of the present invention. Other components include: heat stabilizer agents (hindered phenol series, hydroquinone series, phosphite series and substituted products thereof), weathering agents (resorcinol series, salicylate series, benzotriazole series, benzophenone series, hindered amine series, etc.), release agents and lubricants (montanic acid and its metal salts, its esters, its half esters, stearyl alcohol, stearamide, various bisamides, and bisureas etc.), pigments (cadmium sulfide, phthalocyanine, carbon black for coloring, etc.), dyes (nigrosine, etc.), plasticizers (octyl p-oxybenzoate, N-butylbenzenesulfonamide, etc.), antistatic agents (alkyl sulfate anions antistatic agent, grade 4 ammonium salt type cationic antistatic agent, nonionic antistatic agents such as polyoxyethylene sorbitan monostearate, and betaine amphoteric antistatic agent, etc.), flame retardants (for example, red phosphorus, phosphate ester, melamine cyanurate, hydroxides such as magnesium hydroxide and aluminum hydroxide, ammonium polyphosphate, brominated polystyrene, brominated polyphenylene ether, brominated polycarbonate, brominated epoxy resins or combinations of these brominated flame retardants with antimony trioxide), and other polymers (for example, amorphous resins such as polyamideimide, polyarylate, polyethersulfone, polysulfone, polyphenylene ether, etc.)

In the polyphenylene sulfide resin composition of the present invention, it is preferable that the components (A) to (D) and other components mixed as necessary are uniformly dispersed. As a method for producing the polyphenylene sulfide resin composition of the present invention, for example, a method of melt kneading each component using a known melt kneader such as a single or twin screw extruder, a Banbury mixer, a kneader, or a mixing roll, can be used. Each component may be mixed in advance and then melt kneaded.

In addition, as a method of charging each component into the melt-kneader, for example, using a single-screw or twin-screw extruder, the above (A), (B), and (C) components are supplied from the main charging port installed on the screw base side, (D) carbon fiber is supplied from a sub input port installed between the main input port and the tip of the extruder, and melt-mixed.

The melt kneading temperature is preferably 220° C. or higher, and more preferably 280° C. or higher, in terms of excellent fluidity and mechanical properties. Moreover, 400° C. or less is preferable and 360° C. or less is more preferable. Here, the melt kneading temperature refers to the set temperature of the melt kneader, and refers to the cylinder temperature in the case of a twin screw extruder, for example.

The PPS resin composition of the present invention has excellent friction and wear characteristics and high impact resistance, and is therefore useful to make molded products or articles for electronic devices, automobile parts, structural parts, mechanical parts, petroleum drilling/transporting parts, and the like. Structural parts include, for example, piping parts such as fittings and pipes, electrical and electronic equipments, automobile parts applications, various sealing parts, etc. Oil drilling/transporting parts includes, for example, drills and guides for oil drilling.

### EXAMPLES

Hereinafter, the present invention will be described more specifically with reference to embodiments. However, the present invention is not limited to the description of these embodiments.

Measuring Method

(1) Amount of Chloroform Extracted from PPS Resin

Using a Soxhlet extractor, extract about 10 g of a PPS sample and 200 ml of chloroform for 5 hours, dry the extract at 50° C., and obtain the residue. Calculate resulting residue divided by the amount of PPS sample charged, and multiply by 100 to express the extracted amount in a percentage.

(2) PPS Resin Melt Flow Rate (MFR)

The measurement temperature was 315.5° C. with 5000 g load, and the measurement was performed by a method according to ASTM-D1238-70.

(3) Impact Strength (Notched Impact Test)

Measured according to ISO 179-1.

(4) Wear Measurement

The resin composition pellets were supplied to an injection molding machine manufactured by Sumitomo Heavy Industries, Ltd. (SE 50 DUZ-C160) to form plate-shaped samples each having a dimension of 80 mmm×80 mm×3 mm. The temperature of the cylinder of the injection molding machine was set to 310° C., and a mold temperature was set to 145° C. The obtained plates were processed to obtain test plates (1) of 30 mm×30 mm×3 mm (as shown in the FIGURE). A thrust type friction and wear tester (EFM-III-E) manufactured by Orientec Co., Ltd. was used to evaluate wear resistance properties. An amount of wear is measured by rotating a cylindrical object (2) on the test plate in the direction of 3 in water at 80° C. as shown in the FIGURE. The cylindrical object (2) was made of SUS 304 and had a dimension of an outer diameter: 25.6 mm×an inner diameter: 20 mm×height: 1 5 mm, so that a contact area (ring shaped portion) with the test plate is 2 cm² as shown in FIGURE. This friction and wear test is a thrust type test conducted in accordance with JIS K 7218 (1986). At the measurement of the amount of wear, a sliding speed is 0.5 m/s, and the load applied to the test plate in the direction (4) in the FIGURE was 2 kg.

Raw Materials Used

(A) Polymerization of PPS

In a 70 liter autoclave equipped with a stirrer, 8.27 kg (70.00 mol) of 47.5% sodium hydrosulfide, 2.94 kg (70.63 mol) of 96% sodium hydroxide, 11.45 kg (115.50 mol) of N-methyl-2-pyrrolidone (NMP), 1.89 kg (23.1 mol) of sodium acetate, and 5.50 kg of ion-exchanged water, are charged and gradually heated to 245° C. over about 3 hours under nitrogen at normal pressure. After distilling out 9.77 kg of water and 0.28 kg of NMP, the reaction vessel was cooled to 200° C. The residual water content in the system per 1 mol of the charged alkali metal sulfide was 1.06 mol including the water consumed for the hydrolysis of NMP. The amount of hydrogen sulfide scattered was 0.02 mol per 1 mol of the alkali metal sulfide charged.

Thereafter, the mixture was cooled to 200° C., 10.42 kg (70.86 mol) of p-dichlorobenzene and 9.37 kg (94.50 mol) of NMP were added, the reaction vessel was sealed under nitrogen gas, heated from 200° C. to 270° C. at a rate of 6° C./min., and then reacted at 270° C. for 140 minutes. Thereafter, 2.40 kg (133 mol) of water was injected while cooling from 270° C. to 250° C. over 15 min. Next, the mixture was gradually cooled from 250° C. to 220° C. over 75 minutes, and then rapidly cooled to near room temperature, and the contents were taken out.

The contents were diluted with about 35 liters of NMP, stirred as a slurry at 85° C. for 30 minutes, and then filtered through an 80 mesh wire mesh (aperture 0.175 mm) to obtain a solid material. The obtained solid material was similarly washed and filtered with about 35 liters of NMP. The operation of diluting the obtained solid material with 70 liters of ion-exchanged water, stirring at 70° C. for 30 minutes, and filtering through an 80 mesh wire net to recover the solid material, was repeated a total of 3 times.

The obtained solid material and 32 g of acetic acid were diluted with 70 liters of ion exchange water, stirred at 70° C. for 30 minutes, then filtered through an 80 mesh wire net, and further obtained solid material was diluted with 70 liters of ion exchange water, stirred at 70° C. for 30 minutes, and then filtered through an 80 mesh wire net to recover a solid material. The solid material thus obtained was dried at 120° C. under a nitrogen stream to obtain dry PPS. The obtained PPS had melt flow rate (MFR) of 300 g/10 min.

(B) Glycidyl Group-Containing Copolymer

B-1: Ethylene/methyl acrylate/glycidyl methacrylate copolymer (Arkema Rotada AX8900)

B-2: Ethylene/glycidyl methacrylate copolymer (Bond First E manufactured by Sumitomo Chemical Co., Ltd.)

(C) Fluororesin

C-1: Fluororesin (Zonyl MP1000 manufactured by The Chemours Company, average particle size 5 μm-20 μm)

C-2: Fluororesin (MC Yamasan Polimas Co., Ltd.—Ace Flon SG 1000, average particle size 29 μm-35 μm)

(D) Carbon fiber

D1: Carbon fiber chopped strand (TV 14-0063 mm long, average fiber diameter 6 μm, manufactured by Toray Industries, Inc.)

(E) Glass Fiber

E1: Glass fiber (T-760H manufactured by Nippon Electric Glass Co., Ltd., 3 mm long, average fiber diameter 10.5 μm).

### Examples 1 to 8

As shown in Table 1, the composition of the resin composition was changed. The components (A), (B), and (C) were supplied from the main charging port of the twin-screw extruder, the component (D) was supplied from the sub input port installed between the main input port and the tip of the extruder, the mixture was melt-kneaded with a twin-screw extruder having a screw diameter of 26 mm at a cylinder temperature set at 300° C. Then the mixture was pelletized by a strand cutter. Molding and evaluation were performed using pellets dried overnight at 120° C.

TABLE 1

| Composition | | Examples | | | | | | | |
|---|---|---|---|---|---|---|---|---|---|
| (parts by weight) | | 1 | 2 | 3 | 4 | 5 | 6 | 7 | 8 |
| (A) PPS resin | A1 | 100 | 100 | 100 | 100 | 100 | 100 | 100 | 100 |
| (B) Glycidyl | B1 | 13 | 8 | 18 | 13 | 13 | 13 | | 13 |
| group-containing | B2 | | | | | | | 13 | |
| copolymer | | | | | | | | | |
| (C) Fluororesin | C1 | 4 | 4 | 4 | 8 | 4 | 4 | 4 | |
| | C2 | | | | | | | | 4 |
| (D) Carbon fiber | D1 | 13 | 13 | 13 | 13 | 8 | 18 | 13 | 13 |
| Wear amount (mg) | | 2.6 | 2 | 3.8 | 2.4 | 1.8 | 3.3 | 2.7 | 2.9 |
| Impact Strength | | 10 | 8 | 13 | 7 | 7 | 16 | 9 | 9 |
| (ISO 179) (KJ/m²) | | | | | | | | | |

### Comparative Examples 1 to 5

As shown in Table 2, the amounts or components of the resin composition were changed. The components (A), (B), and (C) were supplied from the main charging port of the twin-screw extruder, the components (D) and (E) were supplied from the sub input port installed between the main input port and the tip of the extruder, the mixture was melt-kneaded with a twin-screw extruder having a screw diameter of 26 mm at a cylinder temperature set at 300° C. Then the mixture was pelletized by a strand cutter. Molding and evaluation were performed using pellets dried overnight at 120° C. In each case, the impact strength and the wear characteristics were inferior.

TABLE 2

| Composition | | Comparative Examples | | | | |
|---|---|---|---|---|---|---|
| (parts by weight) | | 1 | 2 | 3 | 4 | 5 |
| (A) PPS resin | A1 | 100 | 100 | 100 | 100 | 100 |
| (B) Glycidyl | B1 | 0 | 13 | 13 | 13 | 13 |
| group-containing | | | | | | |
| copolymer | | | | | | |
| (C) Fluororesin | C1 | 4 | 0 | 4 | 4 | 4 |
| (D) Carbon fiber | D1 | 13 | 13 | 0 | 25 | |
| (E) Glass fiber | E1 | | | | | 13 |
| Wear amount (mg) | | 2.7 | 5.1 | 1.8 | 4.3 | 6.3 |
| Impact Strength | | 5 | 9 | 5 | 16 | 9 |
| (ISO 179) (KJ/m²) | | | | | | |

In accordance with the present invention, the frictional wear characteristics of the molded product made from the polyphenylene sulfide resin composition, particularly at high temperature and in a solution, are significantly improved, and the excellent impact strength is attained. Thus, the polyphenylene sulfide resin composition of the present invention is useful in a wide range of fields such as electronics parts, structural parts, mechanical parts, oil drilling/transportation parts, which need friction wear resistance and slidability.

1. A polyphenylene sulfide resin composition comprising:
a polyphenylene sulfide resin (A);
a glycidyl group-containing copolymer (B) containing an α-olefin and an α, β-unsaturated glycidyl ester;
a fluororesin (C); and
a carbon fiber (D),
wherein the polyphenylene sulfide resin composition comprises:
5-20 parts by weight of the glycidyl group-containing copolymer (B),
1-10 parts by weight of the fluororesin (C), and
5-20 parts by weight of the carbon fiber (D)
based on 100 parts by weight of the polyphenylene sulfide resin (A).

2. The polyphenylene sulfide resin composition according to claim 1, wherein
the polyphenylene sulfide resin composition is obtained by blending the polyphenylene sulfide resin (A), the glycidyl group-containing copolymer (B), particles of the fluororesin (C), and the carbon fiber (D), wherein
the particles of the fluororesin (C) have average particle size of 1 μm to 30 μm determined in accordance with ISO 12086-2.

3. The polyphenylene sulfide resin composition according to claim 1, wherein
the glycidyl group-containing copolymer (B) is an ethylene/methyl acrylate/glycidyl methacrylate copolymer.

4. The polyphenylene sulfide resin composition according to claim 1, wherein
an amount of the glycidyl group-containing copolymer (B) is 8-16 parts by weight based on 100 parts by weight of the polyphenylene sulfide resin (A).

5. The polyphenylene sulfide resin composition according to claim 1, wherein
an amount of the fluororesin (C) is 2-8 parts by weight based on 100 parts by weight of the polyphenylene sulfide resin (A).
